(19) United States
(12) Patent Application Publication
(10) Pub. No.: US 2012/0217105 A1
(43) Pub. Date: Aug. 30, 2012

(54) ELECTROMAGNETIC SUSPENSION SYSTEM

(76) Inventors: Tomoyuki LEE, Yokohama-shi (JP); Noriyuki UTSUMI, Setagaya-ku (JP)

(21) Appl. No.: 13/405,552

(22) Filed: Feb. 27, 2012

(30) Foreign Application Priority Data
Feb. 28, 2011 (JP) 041765/2011

(51) Int. Cl. F16F 15/03

(52) U.S. Cl. 188/267

(57) ABSTRACT

The present invention provides an electromagnetic suspension system including a casing attachable to a first attachment target member, a movable element, and an armature. One of the movable element and the armature is fixedly disposed in the casing, and the other of the movable element and the armature is movably disposed in the casing. A rod extending in a direction of the relative movement is disposed at the other of the movable element and the armature movably disposed in the casing. The rod extends through a rod guide disposed at the casing to protrude to an outside of the casing, and is configured to be attachable to a second attachment target member. The electromagnetic suspension system further comprises a rotational mechanism allowing a relative rotation between the first attachment target member and the second attachment target member.

### BACKGROUND OF THE INVENTION

1. Field of the Invention

The present invention relates to an electromagnetic suspension system preferably for use in absorption of vibrations of a vehicle.

2. Technical Field of the Invention

Generally, vehicles such as automobiles are provided with a shock absorber disposed between the vehicle body side and the vehicle wheel side. One known type of such a shock absorber is an electromagnetic suspension system using a flat plat-like linear motor (for example, refer to Japanese Patent Public Disclosure Nos. 09-121529, 2006-74987, and 2010-141978). According to the conventional technique, an electromagnetic suspension system is configured to include magnets disposed on both front and back surfaces of a flat plate-like movable element and an armature including a plurality of magnetic poles disposed to face the both surfaces of the movable element.

On the other hand, according to the conventional technique, the electromagnetic suspension system is configured in such a manner that the movable element is sandwiched between the magnetic poles of the armature, and therefore it is impossible to cause a relative rotation between the movable element and the armature, although the length of the electromagnetic suspension system can be increased or reduced in the extension direction of the movable element.

However, when the electromagnetic suspension system is mounted on a vehicle such as an automobile, the electromagnetic suspension system is supposed to receive not only a force in the vertical direction, which corresponds to the stroke direction of the electromagnetic suspension system, but also a force in another direction according to the geometry of the vehicle. For example, an electromagnetic suspension system mounted on a front wheel of an automobile should rotate according to a steering angle of a steering wheel during a cornering operation. Further, for example, when the automobile is running over a protrusion of a road surface or the automobile is having a roll motion, the electromagnetic suspension system receives a force in the lateral direction (hereinafter referred to as “lateral force”) perpendicular to the stroke direction, in addition to the force in the stroke direction. In this way, not only the force in the stroke direction but also a complicated force are applied to the electromagnetic suspension system according to the running condition of the vehicle, which leads to a problem of a difficulty to employ a flat plate-like linear motor to the electromagnetic suspension system without some modification made thereto.

### SUMMARY OF THE INVENTION

The present invention has been contrived in consideration of the above-described problem, and an object of the present invention is to provide an electromagnetic suspension system capable of being easily employed to a vehicle.

According to one aspect of the present invention, an electromagnetic suspension system includes a casing attachable to a first attachment target member, at least one movable element, and at least one armature. One of the movable element and the armature is fixedly disposed in the casing, and the other of the movable element and the armature is movably disposed in the casing. The movable element includes a plurality of magnets disposed in a planar manner. The armature includes a plurality of magnetic poles disposed in a planar manner so that the movable element and the armature can have a relative movement therebetween. A rod extending in a direction of the relative movement is disposed at the other of the movable element and the armature movably disposed in the casing. The rod extends through a rod guide disposed at the casing to protrude to an outside of the casing, and is configured to be attachable to a second attachment target member. The electromagnetic suspension system further comprises a rotational mechanism allowing a relative rotation between the first attachment target member and the second attachment target member.

According to another aspect of the present invention, the at least one movable element includes two movable elements, and the two movable elements are fixed in the casing. Each of the movable elements has a plurality of magnets disposed on front and back surfaces thereof in a planar manner. The armature is movably disposed in the casing, and has a plurality of magnet poles respectively facing the front and back surfaces of the two movable elements. The rod is rotatably connected to a portion of the armature between the two movable elements.

### BRIEF DESCRIPTION OF THE DRAWINGS

FIG. 1 is a vertical cross-sectional view illustrating an electromagnetic suspension system according to a first embodiment of the present invention;

FIG. 2 is a cross-sectional view taken along the line indicated by the arrows II-II shown in FIG. 1;

FIG. 3 is a cross-sectional view taken along the line indicated by the arrows shown in FIG. 1;

FIG. 4 is a vertical cross-sectional view illustrating an electromagnetic suspension system according to a second embodiment of the present invention;

FIG. 5 is a cross-sectional view taken along the line indicated by the arrows V-V shown in FIG. 4;

FIG. 6 is a cross-sectional view taken along the line indicated by the arrows VI-VI shown in FIG. 4;

FIG. 7 is a vertical cross-sectional view illustrating an electromagnetic suspension system according to a third embodiment of the present invention;

FIG. 8 is a cross-sectional view taken along the line indicated by the arrows VIII-VIII shown in FIG. 7;

FIG. 9 is an enlarged vertical cross-sectional view illustrating main parts of an electromagnetic suspension system according to a fourth embodiment of the present invention;

FIG. 10 is a right side view illustrating only a movable element shown in FIG. 9;

FIG. 11 is a cross-sectional view taken along the line indicated by the arrows XI-XI shown in FIG. 10;

FIG. 12 is an enlarged vertical cross-sectional view illustrating main parts of an electromagnetic suspension system according to a fifth embodiment of the present invention;

FIG. 13 is a cross-sectional view taken along the line indicated by the arrows XIII-XIII shown in FIG. 12;

FIG. 14 is an enlarged vertical cross-sectional view illustrating main parts of an electromagnetic suspension system according to a sixth embodiment of the present invention;

FIG. 15 is an enlarged vertical cross-sectional view illustrating main parts of an electromagnetic suspension system according to a seventh embodiment of the present invention; and

FIG. 16 is an enlarged vertical cross-sectional view illustrating main parts of an electromagnetic suspension system according to an eighth embodiment of the present invention.

### DETAILED DESCRIPTION OF THE INVENTION

Hereinafter, electromagnetic suspension systems according to embodiments of the present invention will be described in detail with reference to the accompanying drawings.

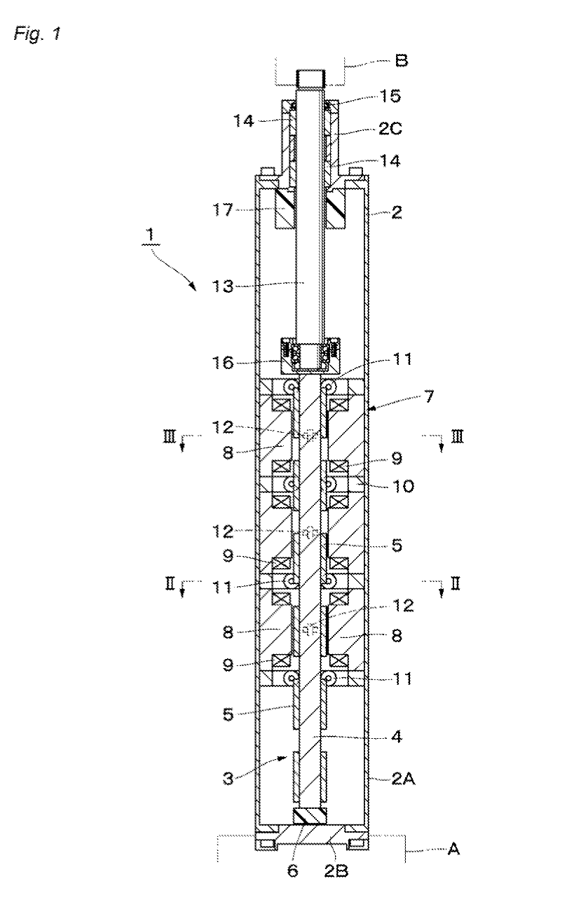

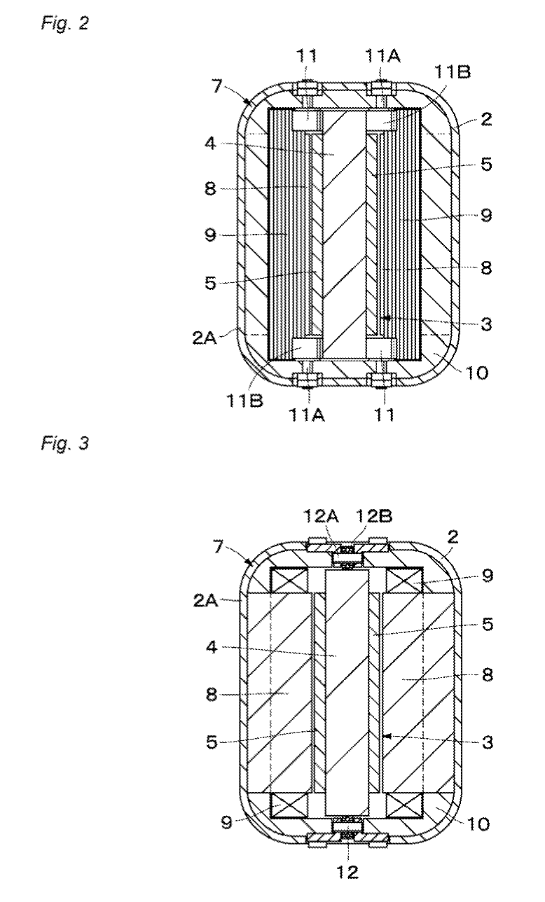

FIGS. 1 to 3 illustrate a first embodiment of the present invention. As illustrated in the drawings, an electromagnetic suspension system 1 includes, for example, a casing 2, a movable element 3, an armature 7, and a rod 13.

The casing 2 is formed into, for example, a polygonal cylinder substantially quadrilateral in cross section. The casing 2 contains the movable element (magnetic member) 3 and the armature 7. The casing 2 includes a cylindrical portion 2A extending in an axial direction, which corresponds to a stroke direction, an attachment portion 2B formed at one end side of the cylindrical portion 2A, and a rod guide support portion 2C formed at the other end side of the cylindrical portion 2A. The attachment portion 2B is formed into a quadrilateral flat plate. The attachment portion 2B is attached to an unsprung member A (for example, an axle) of a vehicle, which corresponds to a first attachment target member. The rod guide support portion 2C is formed into an axially extending cylinder circular in cross section. A rod guide 14, which will be described later, is attached within the rod guide support portion 2C. A sprung member B of a vehicle (for example, a vehicle body), which will be described later, corresponds to a second attachment target member, and a distal end side of the rod 13 is attached to the sprung member B.

The movable element 3 is formed into a flat plate, and extends in the axial direction (the vertical direction as viewed in FIG. 1) along the casing 2. The movable element 3 includes a yolk 4 made of a magnetic body and formed into a flat plate, and a plurality of permanent magnets 5 disposed on the front and back surfaces of the yolk 4 in a planar manner. Two permanent magnets 5 adjacent to each other in the stroke direction (the axial direction) in this state are, for example, polarized so as to have reverse polarities of each other. It should be noted that, in the present disclosure, the name “movable element” includes the term “movable”, and this “movable” is intended to mean movability relative to the armature.

A stopper 6 made of, for example, an elastic member is attached to one end side of the movable element 3. The stopper 6 is disposed so as to be contactable to the attachment portion 28, and functions to reduce an impact when the electromagnetic suspension system 1 is maximally compressed. The rod 13, which will be described later, is connected to the other end side of the movable element 3. The movable element 3 is disposed so as to be axially movable within the casing 2.

The armature 7 includes magnetic poles 8, coils 9, and a core 10. A plurality of magnetic poles 8 is disposed so as to face the front and back surfaces of the movable element 3 in a planar manner. More specifically, three magnetic poles 8 are disposed so as to face the front surface of the movable element 3, and these three magnetic poles 8 are disposed so as to be arranged side by side along the axial direction. Similarly, three magnetic poles 8 are disposed so as to face the back surface of the movable element 3, and these three magnetic poles 8 are disposed so as to be arranged side by side along the axial direction. Further, each of the magnetic poles 8 is formed into a polygonal column extending in the direction perpendicular to the front and back surfaces of the movable element 3. The coil 9 is wound around the outer circumference of the magnetic pole 8. The number of the magnetic poles 8 is not limited to the one illustrated in FIG. 1, and may be any number arbitrarily set according to, for example, a design specification.

The magnetic poles 8 and coils 9 are disposed on the both sides of the movable element 3 in the thickness direction (the right-left direction as viewed in the sheet of FIG. 1). In other words, the magnetic poles 8 and coils 9 are disposed at the front surface side and the back surface side of the movable element 3 so as to sandwich the movable element 3. The two coils 9 opposing in the thickness direction of the movable element 3 are in phase with each other. On the other hand, the two coils 9 adjacent to each other in the stroke direction (the axial direction) are disposed so as to be out of phase with each other by an electric angle of 120 degrees. Therefore, the six coils 9 in total are divided in terms of phase into three groups, each of which is constituted by two coils in phase. For example, among the six coils 9 included in the armature 7, the two coils 9 at the top portion of the armature 7 have a phase U, the two coils 9 at the middle portion of the armature 7 have a phase V, and the two coils 9 at the bottom portion of the armature 7 have a phase W. The two coils 9 in phase may be wired in series or in parallel. How to wire them may be arbitrarily selected according to the voltage and current specification of a drive power source side.

The plurality of magnetic poles 8 are connected to one another via the core 10. The core 10 is formed into a polygonal cylinder quadrilateral in cross section, and the plurality of magnetic poles 8 is attached thereto. The core 10 is fixed to the casing 2.

A plurality of support members 11, which sandwiches the movable element 3 in the thickness direction, is attached to the core 10 in a spaced apart relationship in the stroke direction. Further, a plurality of support members 12, which sandwiches the movable element 3 in a width direction (the front-back direction as viewed in the sheet of FIG. 1), is attached to the core 10 in a spaced-apart relationship in the stroke direction. The support members 11 and 12 include shafts 11A and 12A attached to the core 10, and rollers 11B and 12B rotatably attached to the shafts 11A and 12A. The support members 11 and 12 constitute a slidable mechanism. The support members 11 and 12 allow the movable element 3 and the armature 7 to have a relative movement in the stroke direction. Further, the support members 11 maintain a space between the movable element 3 and the armature 7 in the thickness direction.

In the present embodiment, the support members 11 and 12 are embodied by rolling-element bearings. However, the electromagnetic suspension system 1 may be subject to a high-speed slight vibration, which may lead to unsymmetrical wear of the rolling bearings, resulting in increases in noises and vibrations. In this case, each of the support members 11 and 12 may be embodied by a rolling-element bearing provided with resin such as urethane welded around the roller 11B or 12B, or may be embodied by a sliding bearing.

The rod 13 is connected to the movable element 3 via a rotational mechanism 16, and is configured to be displaced in the axial direction together with the movable element 3. The rod 13 is formed into an axially extending column circular in cross section, and has a proximal end side attached to the rotational mechanism 16 and a distal end side protruding through the rod guide support portion 2C to the outside of the casing 2. The distal end side of the rod 13 is attached to the sprung member B of the vehicle (for example, the vehicle body), which corresponds to the second attachment target member.

Further, a rod guide 14 is attached to the rod guide support portion 2C as a lateral force support mechanism. The rod guide 14 is embodied by, for example, a sleeve bearing. The rod guide 14 allows an axial displacement of the rod 13, and supports a lateral force applied to the rod 13. The rod guide 14 may be embodied by not only a sleeve bearing but also, for example, a rolling-element bearing.

A seal 15 such as an O-ring is disposed at the rod guide support portion 2C at a position on the distal end side beyond the rod guide 14. The seal 15 prevents an entry of, for example, water or dust from the outside to thereby protect the movable element 3 and the armature 7. The rod 13 is disposed so as to penetrate through the rod guide 14 and the seal 15.

The rotational mechanism 16 is disposed at the other end side of the movable element 3, and connects the rod 13 and the movable element 3. The rotational mechanism 16 is embodied by, for example, an angular ball bearing. The rotational mechanism 16 allows a rotation of the rod 13 around the axis extending along the stroke direction.

The rotational mechanism 16 may be embodied by not only an angular ball bearing but also any another member capable of allowing a rotation of the rod 13. Further, a mark indicating an attachment position and a rotational limitation may be provided to the casing 2 and the rod 13, if the electromagnetic suspension system 1 is limited in the rotational angle due to, for example, the structural conditions of the vehicle.

Further, the rotational mechanism 16 is disposed at the outer circumferential side of the rod 13. The casing 2 contains a stopper 17 made of, for example, an elastic material, and disposed around the rod guide support member 2C. The stopper 17 is disposed so as to be contactable with the rotational mechanism 16, and functions to reduce an impact when the electromagnetic suspension system 1 is maximally extended.

The electromagnetic suspension 1 according to the present embodiment is configured as mentioned above, and functions as follows.

When the electromagnetic suspension system 1 is disposed between the unsprung member A and the sprung member B of the vehicle, the electromagnetic suspension system 1 receives not only a force in the stroke direction but also a complicated force in another direction than the stroke direction according to the geometry of the vehicle.

For example, when the vehicle vibrates vertically, a force is applied to the electromagnetic suspension system 1 in the stroke direction. A relative movement is generated between the movable element 3 and the armature 7 according to this force. At this time, it is possible to adjust a damping force of the electromagnetic suspension system 1 by applying arbitrary electric current to the coils 9, and thereby it is possible to improve the ride comfort and steering stability of the vehicle.

The electromagnetic suspension system 1 may include a stroke sensor, and may be configured to control the electric current to be applied to the coils 9 with use of the stroke sensor. In this case, the stroke sensor detects an absolute position, a relative position, or an electric angle between the armature 7 and the movable element 3. As a result, a drive circuit (not illustrated) can supply optimum electric current to the coils 9 to obtain a desired damping force according to the electric angle.

On the other hand, when a steering wheel is operated during, for example, a cornering operation, a force is applied to the electromagnetic suspension system 1 in a direction other than the stroke direction. More specifically, since it is necessary to change the orientation of the wheel according to a driver's operation of the steering wheel in conformity to the travelling direction, a relative rotation is generated between the unsprung member A and the sprung member B, as a result which a force is applied to the electromagnetic suspension system 1 in the rotational direction around the axis of the electromagnetic suspension system 1. At this time, the relative rotation between the unsprung member A and the sprung member B is received by the rotational mechanism 16 disposed between the movable element 3 and the rod 13, and the movable element 3 and the armature 7 are rotated relative to the rod 13.

Further, when the vehicle is running over a protrusion on a road surface or the vehicle has a roll motion, a lateral force is applied to the electromagnetic suspension system 1 in the direction perpendicular to the stroke direction. This lateral force is applied to the rod 13 as well as transmitted to the casing 2 via the rod guide 14. As a result, the lateral force is prevented from being applied to the movable element 3 and the armature 7 so that it is possible to reduce the possibility of a contact between the movable element 3 and the armature 7 under the influence of the lateral force.

As configured in this way, according to the first embodiment, the electromagnetic suspension system 1 is provided with the rotational mechanism 16, which allows a relative rotation between the sprung member B and the unsprung member A to thereby make it possible to employ the electromagnetic suspension system 1 to a widely-used vehicle without changing the conventional structure of the vehicle.

Especially, the rotational mechanism 16 is provided at a connection portion between the rod 13 and the movable element 3, and therefore the existence of the rotational mechanism 16 here allows a relative rotation even between the rod 13 and the movable element 3. In addition, the rotational mechanism 16 can be contained in the casing 2, and therefore the rotational mechanism 16 can be protected from the influence of the outside such as water, mud, and dust.

Further, the electromagnetic suspension system 1 is provided with the rod guide 14 serving as a lateral force support mechanism capable of supporting a lateral force, so that the lateral force applied to the rod 13 can be supported by the casing 2 via the rod guide 14. Therefore, the movable element 3 and the armature 7 can be prevented from receiving the lateral force, so that it is possible to reduce the possibility of a contact between the movable element 3 and the armature 7. As a result, it is possible to reduce generation of uncomfortable noises due to a contact between the movable element 3 and the armature 7 when the vehicle is running, prevent the electromagnetic suspension system 1 from becoming less effective due to a breakage of the wires of the coils 9 disposed at the armature 7 resulting from an impact at the time of the contact, and reduce the possibility of performance deterioration due to generation of a crack at the permanent magnets 5 disposed at the movable element 3 resulting from an impact at the time of the contact, thereby improving the reliability of the electromagnetic suspension system 1.

Further, the casing 2 formed into a polygonal shape in cross section, which facilitates insertion of the flat plate-like movable element 3 and the magnetic poles 8 of the armature 7, which face the front and back surfaces of the movable element 3, into the casing 2. In addition, the movable element 3, the magnetic poles 8 of the armature 7, and the like can be formed into a flat plate, which is an easily processed structure, thereby improving the productivity of the electromagnetic suspension system 1.

In the present embodiment, the profile of the electromagnetic suspension system 1 is quadrilateral in cross section, and therefore it is necessary to prepare a space equal to or larger than the diameter corresponding to the diagonal line of the electromagnetic suspension system 1 at most in preparation for a relative rotation of the electromagnetic suspension system 1. Therefore, for example, in a case where the cross section is rectangular, the electromagnetic suspension system 1 may be disposed so that the long side thereof extends along the traveling direction of the vehicle, thereby enabling the orientation of the electromagnetic suspension system 1 to be changed together with the wheel to prevent the electromagnetic suspension system 1 from contacting, for example, a tool, a cable, and the wheel between the unsprung member A and the sprung member B. In a case where the cross section is a square, the electromagnetic suspension system 1 can be disposed without considering which side should be arranged in the travelling direction of the vehicle.

Further, the plurality of support members 11 and the plurality of support members 12 are disposed between the movable element 3 and the armature 7. The existence of the support members 11 and 12 allows a relative movement between the movable element 3 and the armature 7 in the stroke direction. Further, the support members 11, which are disposed on the both sides of the movable element 3 in the thickness direction, maintain a space between the movable element 3 and the armature 7 in the thickness direction, whereby the support members 11 can prevent a contact between the movable element 3 and the armature 7.

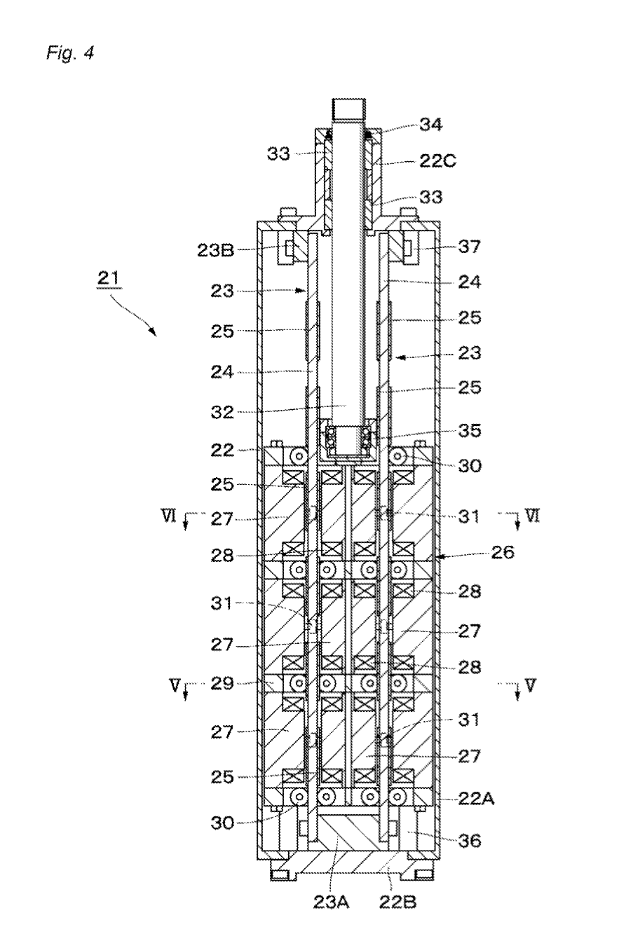

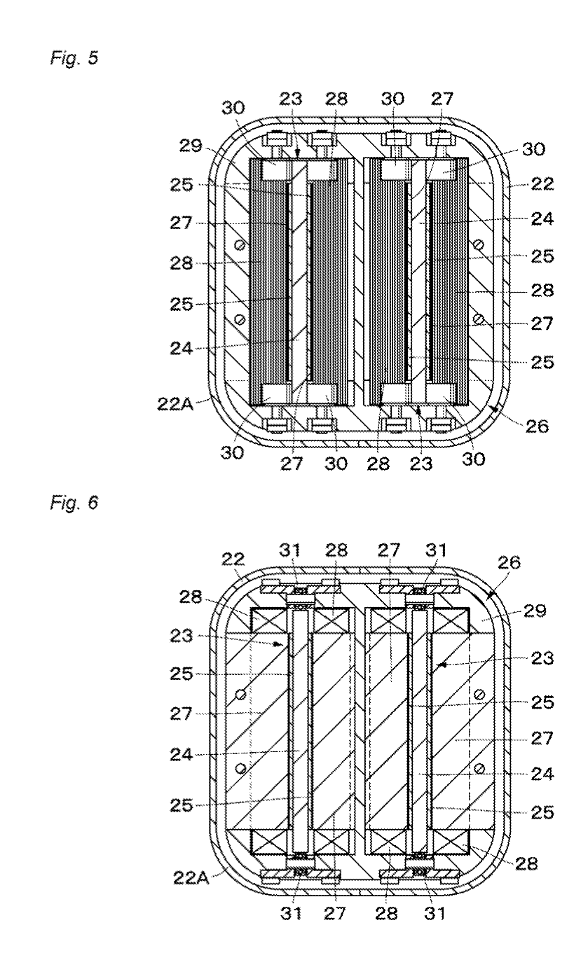

Next, FIGS. 4 to 6 illustrate a second embodiment of the present invention. The second embodiment is characterized in that two movable elements are fixed in the casing while the armature 7 is disposed so as to allow a relative movement between the armature 7 and the movable elements, and a rotatable rod is connected to and disposed at a portion of the armature 7 between the two movable elements.

An electromagnetic suspension system 21 according to the second embodiment includes, for example, a casing 22, movable elements 23, an armature 26, and a rod 32.

The casing 22 is formed into, for example, a polygonal cylinder substantially quadrilateral in cross section, and contains the movable elements 23 and the armature 26. As is the case with the casing 2 in the first embodiment, the casing 22 includes a cylindrical portion 22A, an attachment portion 22B, and a rod guide support portion 22C. The attachment portion 22B is attached to an unsprung member of a vehicle, which corresponds to the first attachment target member. The rod guide support portion 22C is formed into an axially extending cylinder circular cross section. A rod guide 33, which will be described later, is attached within the rod guide support portion 22C.

Each of the movable elements 23 is formed into a flat plate, and is disposed so as to extend along the casing 22 in an axial direction (the vertical direction as viewed in the sheet of FIG. 4). The movable element 23 includes a yolk 24 made of a magnetic body and formed into a flat plate, and a plurality of permanent magnets 25 disposed at the front and back surfaces of the yolk 24 in a planner manner. The two permanent magnets 25 adjacent to each other in this state in the stroke direction (the axial direction) are, for example, polarized so as to have reverse polarities of each other.

Further, the two movable elements 23 are positioned in the casing 22 and are arranged in parallel with each other while being fixed to the casing 22. More specifically, the movable elements 23 are fixedly attached at one end sides thereof in the axial direction to the attachment portion 22B via a fixation member 23A, and are also fixedly attached at the other end sides thereof in the axial direction to the rod guide support portion 22C via a fixation member 23B.

The armature 26 includes magnetic poles 27, coils 28, and a core 29. A plurality of magnetic poles 27 is disposed so as to face the front and back surfaces of one of the movable members 23 in a planar manner, and a plurality of magnetic poles 27 is disposed so as to face the front and back surfaces of the other of the movable elements 23 in a planar manner. More specifically, three magnetic poles 27 are disposed so as to face the front surface of the one movable element 23, and these three magnetic poles 27 are arranged side by side along the axial direction. Further, three magnetic poles 27 are disposed so as to face the back surface of the one movable element 23, and these three magnetic poles 27 are arranged side by side along the axial direction. Similarly, three magnetic poles 27 are also disposed to face each of the front and back surfaces of the other movable element 23. Each of the magnetic poles 27 are formed into a polygonal column extending in a direction perpendicular to the front and back surfaces of the movable elements 23, and the coil 28 is disposed around the outer circumference of the magnetic pole 27. The number of the magnetic poles 27 is not limited to the illustrated one, but may be arbitrarily set according to the design specification.

The magnetic poles 28 and the coils 28 are disposed so as to sandwich each of the two movable elements 23. Then, the four coils 28 facing one another in the thickness direction of the movable elements 23 are in phase with one another. On the other hand, the two coils 28 adjacent to each other in the stroke direction (the axial direction) are disposed so as to be out of phase with each other by an electric angle of 120 degrees. In this way, the twelve coils 28 in total are divided in terms of phase into three groups, each of which is constituted by four coils in phase. For example, referring to FIG. 4, the four coils 28 at the top portion of the armature 26 have a U phase, the four coils 28 at the middle portion of the armature 26 have a V phase, and the four coils 28 at the bottom portion of the armature 26 have a W phase. The four coils 28 in phase may be wired in series or in parallel. How to wire the coils 28 may be arbitrarily set according to the voltage and current specification of a drive power source side.

The plurality of magnetic poles 27 are connected to one another via the core 29. The core 29 is formed into a polygonal cylinder quadrangular in cross section, and the plurality of magnetic poles 27 is attached to the core 29. The armature 26 is positioned in the casing 22, and is disposed so as to be movable relative the casing 22 and the movable elements 23.

A plurality of support members 30, which sandwiches the movable elements 23 in the thickness direction, is attached to the core 29 in a spaced-apart relationship in the stroke direction. Further, a plurality of support members 31, which sandwiches the movable elements 23 in a width direction (the front-back direction as viewed in the sheet of FIG. 4), is attached to the core 29 in a spaced-apart relationship in the stroke direction. Then, the support members 30 and 31 are configured in a substantially similar manner to the support members 11 and 12 in the first embodiment, and constitute a sliding mechanism allowing a relative movement between the movable elements 23 and the armature 26 in the stroke direction. Further, the support members 30 maintain a space between each of the movable elements 23 and the armature 26 in the thickness direction.

The rod 32 is connected to the other end side of the armature 26 via a rotational mechanism 35, and is configured to be axially displaced together with the armature 26. The rod 32 is formed into an axially extending column circular in cross section. The rod 32 has a proximal end side attached to the rotational mechanism 35, and a distal end side protruding to the outside of the casing 22 through the rod guide support portion 22C. The distal end side of the rod 32 is attached to the sprung member of the vehicle, which corresponds to the second attachment target member.

Further, the rod guide 33, which corresponds to the lateral force support mechanism, is attached to the rod guide support portion 22C. The rod guide 33 is configured in a substantially similar manner to the rod guide 14 in the first embodiment, and allows an axial displacement of the rod 32 while supporting a lateral force applied to the rod 32. Further, a seal 34 such as an O-ring is attached to the rod guide support portion 22C at a position on the distal end side beyond the rod guide 33.

The rotational mechanism 35 is attached to the other end side of the armature 26, and connects the rod 32 to the armature 26. The rotational mechanism 35 is configured in a substantially similar manner to the rotational mechanism 16 in the first embodiment, and allows a rotation of the rod 32 around the axis along the stroke direction.

Further, the casing 22 contains stoppers 36 and 37 disposed at the both sides in the axial direction, and made of, for example, elastic materials. The stopper 36 is disposed so as to be contactable with one end side of the armature 26, and reduces an impact when the electromagnetic suspension system 21 is maximally compressed. On the other hand, the stopper 37 is disposed so as to be contactable with the other end side of the armature 26, and reduces an impact when the electromagnetic suspension system 21 is maximally extended. Further, a stopper may be provided near the rod guide support member 22C within the casing 22 for reducing an impact applied to the rotational mechanism 35 when the electromagnetic suspension system 21 is maximally extended.

As configured in this way, the second embodiment can provide advantageous effects substantially similar to those of the first embodiment. Generally, an electromagnetic suspension system is required to achieve thrust enhancement to improve the ride comfort and maintain the steering stability. Further, it is preferable that an electromagnetic suspension system provides a stronger resistive force against a stroke speed generated when the coils of three phases are shorted to effectively regenerate vibration energy while the vehicle is running, i.e., it is preferable that an electromagnetic suspension system has a large damping force coefficient.

To satisfy these requirements, according to the second embodiment, the electromagnetic suspension system 21 includes the two movable elements 23 fixed in the casing 22, and the armatures 26 movable relative to these movable elements 23. Therefore, it is possible to increase the surface area of the movable elements 23 facing the armature 26 compared to the first embodiment, thereby increasing the thrust force and the damping coefficient.

Further, since the armature 26 is disposed along the central line of the electromagnetic suspension system 21, the rod 32 can be disposed at the central portion of the armature 26 via the rotational mechanism 35. Therefore, the axial length of the casing 22 can be reduced, and the structure of the casing 22 can be simplified, leading to a reduction in the whole length of the electromagnetic suspension system 21. As a result, it is possible to improve the installability to the vehicle, and enhance the performance and increase the stroke length since the lengths of the armature 26 and the movable elements 23 can be increased by adding a length corresponding to the reduction in the whole length, thereby achieving maintenance of a stroke of the vehicle and performance enhancement of the electromagnetic suspension system 21.

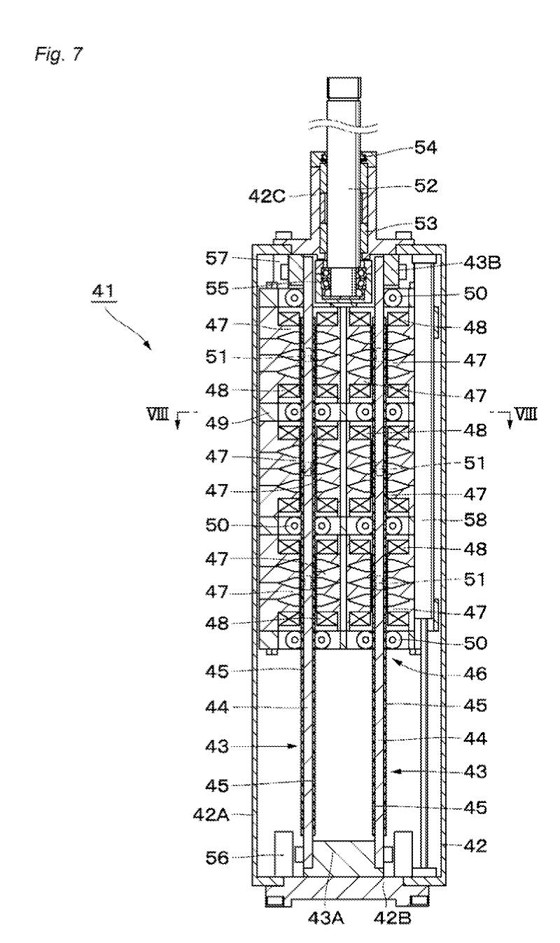

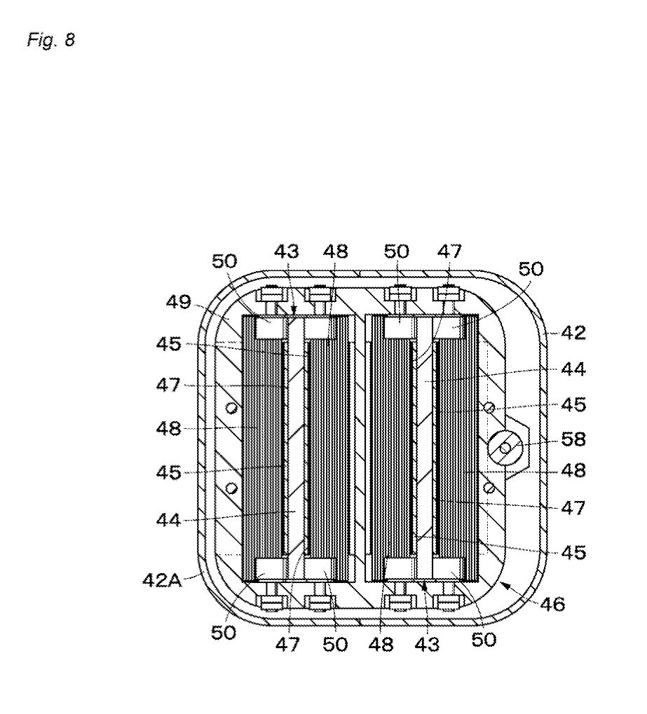

Next, FIGS. 7 and 8 illustrate a third embodiment of the present invention. The third embodiment is characterized in that a single coil is wound around a plurality of magnetic poles as a common coil.

An electromagnetic suspension system 41 according to the third embodiment includes, for example, a casing 42, movable elements 43, an armature 46, and a rod 52.

The casing 42 is formed into, for example, a polygonal cylinder substantially quadrilateral in cross section. The casing 42 contains the movable elements 43 and the armature 46. As is the case with the casing 22 in the second embodiment, the casing 42 includes a cylindrical portion 42A, an attachment portion 42B, and a rod guide support portion 42C. The attachment portion 42B is attached to the unsprung member of the vehicle as the first attachment target member. The rod guide support portion 42C is formed into an axially extending cylinder circular in cross section. The rod guide support portion 42C contains a rod guide 53 attached therein, which will be described later.

The movable element 43 is formed into a flat plate, and axially extends along the casing 42 (the vertical direction as viewed in the sheet of FIG. 7). The movable member 43 includes a yolk 44 made of a magnetic body and formed into a flat plate, and a plurality of permanent magnets 45 disposed on the front and back surfaces of the yolk 44 in a planar manner. Two permanent magnets 45 adjacent to each other in the stroke direction (the axial direction) in this state are, for example, polarized so as to have reverse polarities of each other.

Further, two movable elements 43 are disposed in parallel with each other in the casing 42 in a substantially similar manner to the movable elements 23 in the second embodiment, and each have the both end sides fixed to the casing 42 with use of fixation members 43A and 43B.

The armature 46 includes magnetic poles 47, coils 48, and a core 49. A plurality of magnetic poles 47 is disposed in a planar manner to face the front and back surfaces of one of the movable elements 43. Further, a plurality of magnetic poles 47 is disposed in a planar manner to face the front and back surfaces of the other of the movable elements 43.

More specifically, twelve magnetic poles 47 are disposed at the armature 46 so as to face the front surface of the one movable element 43, and these twelve magnetic poles 47 are arranged side by side along the axial direction. Further, twelve magnetic poles 47 are disposed at the armature 46 so as to face the back surface of the one movable element 43, and these twelve magnetic poles 47 are arranged side by side along the axial direction. Similarly, twelve magnet poles 47 are disposed to face each of the front and back surfaces of the other movable element 43.

The twelve magnet poles 47 arranged in the axial direction are divided into three groups, each of which is constituted by four magnetic poles 47. A common coil 48 is wound around the four magnetic poles 47 of the respective groups. Further, the pitch between axially adjacent two magnetic poles 47 in each group is, for example, set based on a distance τp between a north pole of the permanent magnet 45 to the next north poles of the permanent magnet 45 in the axial direction, i.e., substantially twice of the pitch between two permanent magnets 45 adjacent to each other in the axial direction. Therefore, the pitch between the magnetic poles 47 may be set to the distance τp, or may be set to a distance different from the distance τp by arbitrary angle such as an electric angle of approximately 5 degrees or 10 degrees for the purpose of reducing a thrust pulse applied between the armature 46 and the moving element 43. The number of the magnetic poles 47 is not limited to the illustrated one, but may be arbitrarily set according to, for example, the design specification.

The magnetic poles 47 and the coils 48 are disposed so as to sandwich each of the two movable elements 43 therebetween. The four coils 48 facing in the thickness direction of the movable elements 43 are in phase with one another. On the other hand, two coils 48 adjacent to each other in the stroke direction (the axial direction) are disposed so as to be out of phase with each other by an electric angle of 120 degrees. Therefore, the twelve coils 48 in total are divided into three groups, each of which is constituted by four coils in phase. For example, referring to FIG. 7, the four coils 48 at the top portion of the armature 46 have a U phase, the four coils 48 at the middle portion of the armature 46 have a V phase, and the four coils 48 at the bottom portion of the armature 46 have a W phase. The four coils 48 in phase may be wired in series or in parallel. How to wire them may be arbitrarily selected according to the voltage and current specification of a drive power source side.

The plurality of magnetic poles 47 are connected to one another via the core 49. The core 49 is formed into a polygonal cylinder quadrilateral in cross section, and the plurality of magnetic poles 47 are attached to the core 49. The armature 46 is disposed in the casing 42 so as to be movable relative to the casing 42 and the movable elements 43.

A plurality of support members 50, which sandwiches the movable elements 43 in the thickness direction, is attached to the core 49 in a spaced apart relationship in the stroke direction. Further, a plurality of support members 51, which sandwiches the movable elements 43 in the width direction (the front-back direction as viewed in FIG. 7), is attached to the core 49 in a spaced-apart relationship in the stroke direction. The support members 50 and 51 are configured in a substantially similar manner to the support members 11 and 12 in the first exemplary embodiment. The support members 50 and 51 constitute a sliding mechanism allowing the movable element 43 and the armature 47 to have a relative movement in the stroke direction. Further, the support members 50 maintain a space between each of the movable elements 43 and the armature 46 in the thickness direction.

The rod 52 is connected to the other end side of the armature 46 via a rotational mechanism 55, and is configured to be axially displaced together with the armature 46. The rod 52 is formed into an axially extending column circular in cross section, and has a proximal end side attached to the rotational mechanism 55, and has a distal end side protruding to the outside of the casing 42 through the rod guide support portion 42C. The distal end side of the rod 52 is attached to the sprung member of the vehicle as the second attachment target member.

Further, a rod guide 53, which functions as a lateral force support mechanism, is attached to the rod guide support portion 42C. The rod guide 53 is configured in a substantially similar manner to the rod guide 14 in the first embodiment, and allows an axial displacement of the rod 52 while supporting a lateral force applied to the rod 52. Further, a seal 54 is disposed at the rod guide support portion 42C at a position on the distal end side beyond the rod guide 53.

The rotational mechanism 55 is attached to the other end side of the armature 46, and connects the rod 52 to the substantially similar manner to the rotational mechanism 16 in the first embodiment, and allows a rotation of the rod 52 around the axis extending in the stroke direction. Further, the casing 42 contains stoppers 56 and 57 disposed at the both end sides of the axial direction and made of, for example, elastic materials.

Further, a stroke sensor 58 is mounted on the armature 46. The stroke sensor 58 is constituted by, for example, a potentiometer for measuring a linear distance between the attachment portion 42B and the armature 46, and measures a relative positional relationship between the armature 46 and the movable elements 43. Use of this sensor enables a supply of optimum electric current to the coils 48 based on the information acquired from the stroke sensor 58. The stroke sensor 58 may be embodied by not only a potentiometer but also any sensor capable of measuring a relative distance between the armature 46 and the movable elements 43 or absolute distances thereof, such as a hole element or a laser displacement detector. Alternatively, the stroke information may be detected by detecting a rotational angle of rolling-element bearings.

As configured in this way, the third embodiment can also provide substantially similar advantageous effects to those of the first and second embodiments. Especially, the third embodiment is configured in such a manner that the common coil 48 is wound around the four magnet poles 47, and therefore it is possible to increase the damping coefficient of the electromagnetic suspension system 41. This advantageous effect will be described now in more detail.

Generally, it is preferable that an electromagnetic suspension system provides a stronger resistive force against a stroke speed generated when the coils of three phases are shorted to effectively regenerate vibration energy while the vehicle is running, i.e., it is preferable that an electromagnetic suspension system has a large damping force coefficient.

This damping force coefficient C can be obtained from the following equation (1). The damping force coefficient C is proportional to a back electromotive force coefficient Ke and inversely proportional to the square of a resistor value R.

$$C = 3 \frac{{K}_{e}}{{R}^{2}} \qquad [ EQUATION 1 ]$$

In other words, it is desirable that the electromagnetic suspension system has a small resistance value R, and a large back electromotive force coefficient Ke. The back electromotive voltage e generated at a coil wound n times is calculated by the following equation 2 according to Faraday's law of induction.

$$e = - n \frac{d φ}{d t} \qquad [ EQUATION 2 ]$$

Assuming that an interlinkage magnetic flux φ is sinusoidally changed at an amplitude φm and an angular speed ω (ω=2nf) (φ=φₘ cos ωt), a value E of the back electromotive voltage is calculated by the following equation 3.

$$E = \vert - n \frac{d {φ}_{m} cos ω t}{d t} \vert = \vert n {ωφ}_{m} sin ω t \vert = n 2 π f {φ}_{m} \qquad [ EQUATION 3 ]$$

According to the equation 3, the back electromotive voltage can be increased by increasing the number of coil windings n, increasing the frequency f, or increasing the amplitude φm of the interlinkage magnetic flux φ. Among the three options, the number of coil windings n is limited by the outer dimension of the electromagnetic suspension system, and the interlinkage magnetic flux is limited by the retention ability and the residual magnetic flux density of the permanent magnet, and the space between the permanent magnet and the magnetic pole. On the other hand, the frequency can be adjusted by the design of the armature and the movable element. Therefore, it is desirable to increase the frequency to increase the damping coefficient C.

However, the number of the magnetic poles at the armature and the movable element should be increased to increase the frequency f. Under the condition that the outer dimension of the electromagnetic suspension system is fixedly determined, an increase in the number of magnetic poles should be achieved by reducing the dimension of each coil and permanent magnet. However, although the permanent magnet is a mechanically processed part and therefore can be easily reduced in size, a reduction in the size of the coil may lead to an increase in the volume occupied by an insulator per coil, thereby reducing the lamination factor to deteriorate the performance. In addition, the increase in the number of coils leads to an increase in the number of wire connections between the coils to reduce the manufacturability of the armature.

In consideration of these circumstances, the present embodiment is configured in such a manner that the common coil 48 is wound around the plurality of (four) magnetic poles 47. As result, it is possible to increase the frequency of a change in the magnetic flux to increase the damping coefficient C while preventing the outer dimension of the electromagnetic suspension system 41 from being increased compared to the second embodiment.

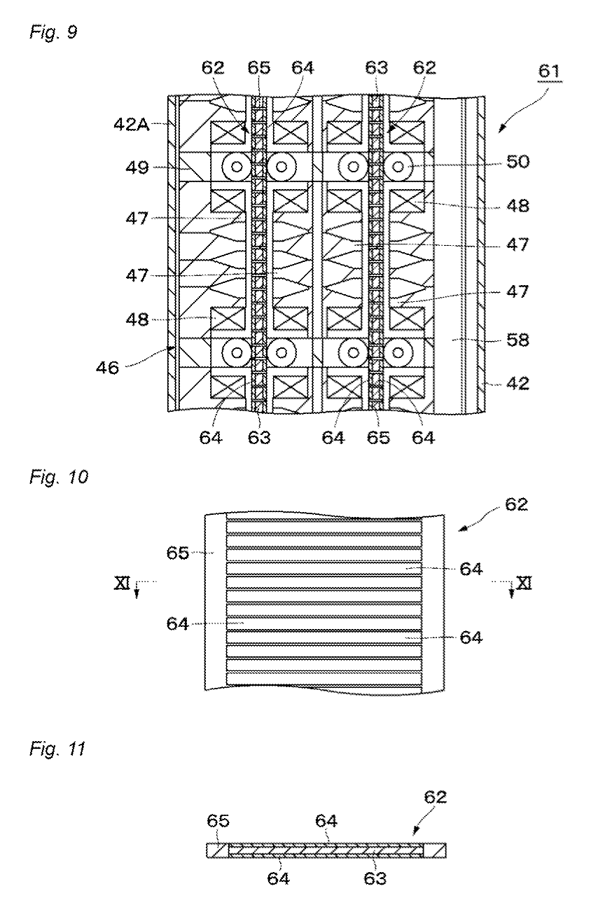

Next, FIGS. 9 to 11 illustrate a fourth embodiment of the present invention. The fourth embodiment is characterized in that permanent magnets of movable elements are attached to a magnet fixation member made of a nonmagnetic body. In the following description, like components will be denoted by the same reference numerals as those in the above-described third embodiment, and the descriptions thereof will be omitted.

An electromagnetic suspension system 61 according to the fourth embodiment is configured in a substantially similar manner to the electromagnetic suspension system 41 in the third embodiment. However, a movable element 62 includes a magnet connection member 63 made of a magnetic body, two permanent magnets 64 sandwiching the magnet connection member 63, and a ladder-structured magnet fixation member 65 made of a nonmagnetic body, into which the magnet connection member 63 is embedded. Then, the movable element 62 is sandwiched by the magnetic poles 47 and the coils 48 of the armature 46.

As configured in this way, the fourth embodiment can provide substantially similar advantageous effects to those of the third embodiment. The third embodiment is configured in such a manner that the movable element 43 includes the permanent magnets attached to the both surfaces of the yolk 44 made of a magnetic member. In this case, the provision of the yolk 44 made of a magnetic body between the permanent magnets 45 enables virtual generation of a large magnet with a reduced amount of magnets. However, a large amount of magnetic body should be used in this case, thereby increasing an attractive force applied between the armature 46 and the movable element 43, which may lead to a deflection of the movable element 43 and application of a large load onto the support members 50.

On the other hand, in the fourth embodiment, the movable element 62 includes the magnet fixation member 65 made of a nonmagnetic body, and therefore it is possible to reduce the use amount of the magnetic body in the movable element 62, thereby reducing the attractive force applied between the armature 7 and the movable element 62, also reducing the load applied to the support members 50. Further, this also reduce the required strength for maintaining the rigidity of the movable element 62, and therefore it is possible to make the movable element 62 thinner to reduce the size and weight thereof.

Further, at the movable element 43 in the third embodiment, the magnetic flux output from the permanent magnet 45 on the front surface side is divided into two routes, the magnetic flux toward the back-side permanent magnet 45 facing the front-side magnet in the thickness direction via the yolk 44, and the magnetic flux toward the permanent magnet 45 adjacent to each other in the axial direction. The magnetic flux toward the axially adjacent permanent magnet 45 turns out a flux leakage, and is not contributive to generation of a thrust force.

On the other hand, in the fourth embodiment, the permanent magnet 64 is attached to the magnet fixation member 65 made of a nonmagnetic body. Therefore, the magnetic flux output from the permanent magnet 64 on the front surface side flows toward the permanent magnet 64 on the back surface side through the magnet connection member 63 made of a magnetic body. On the other hand, the magnet fixation member 65 made of a nonmagnetic body is provided between the axially adjacent permanent magnets 64, which results in a reduction in the magnetic flux flowing toward the axially adjacent permanent magnet 64, compared to the third embodiment. As a result, it is possible to reduce a flux leakage, and therefore enhance the thrust force and improve the damping coefficient.

The fourth embodiment has been described based on an example in which the movable element 62 is applied to the electromagnetic suspension system similar to the third embodiment. However, in the fourth embodiment, the movable element 62 may be applied to the electromagnetic suspension systems 1 and 21 according to the first and second embodiments.

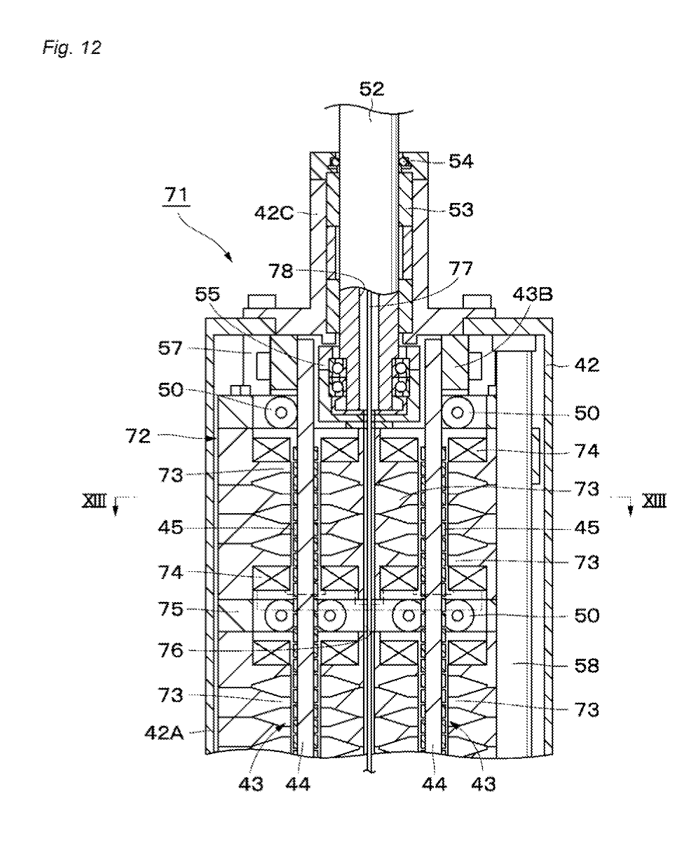

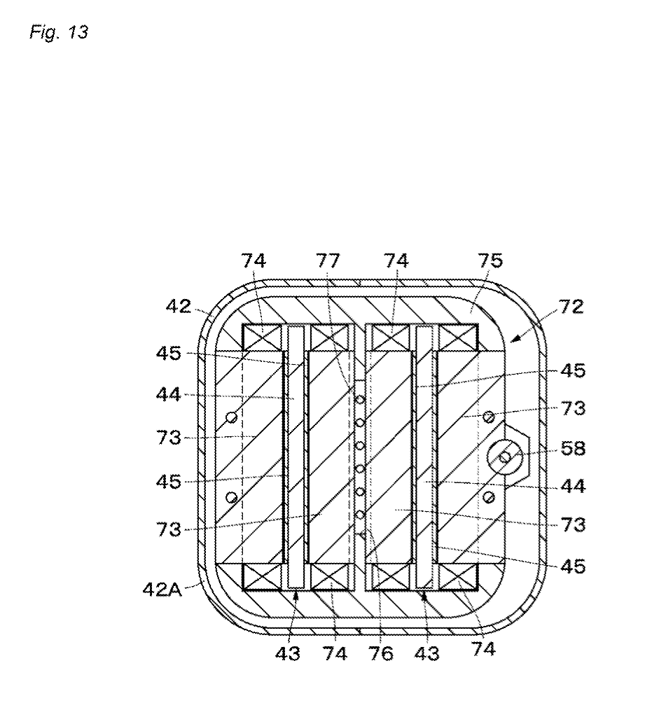

Next, FIGS. 12 and 13 illustrate a fifth embodiment of the present invention. The fifth embodiment is characterized in that a space for wiring is formed between a plurality of coils stacked in the thickness direction of the movable elements, and a wiring for coils is disposed in the space for wiring. In the following description, like components will be denoted by the same reference numerals as those in the above-described third embodiment, and the descriptions thereof will be omitted.

An electromagnetic suspension system 71 according to the fifth embodiment is configured in a substantially similar manner to the electromagnetic suspension system 41 according to the third embodiment of the present invention. Further, an armature 72 is configured in a substantially similar manner to the armature 46 in the third embodiment, and includes magnetic poles 73, coils 74, and a core 75. Four sets of magnetic poles 73 and coils 74 are stacked in the thickness direction of the movable elements 43. The armature 72 includes an axially extending wiring space 76 formed between the second coil 74 and the third coil 74 among the four coils 74. A wiring 77 for supplying power to the coils 74 is disposed in the wiring space 76. Further, a rod 52 has a hollow structure including an axially extending through-hole 78, and the wiring 77 is guided to the outside through the through-hole 78.

As configured in this way, the fifth embodiment can also provide advantageous effects substantially similar to those of the third embodiment. Especially, in the fifth embodiment, the wiring space 76 is formed between the plurality of coils 74 stacked in the thickness direction of the movable elements 43, and the wiring 77 is disposed in the wiring space 76. Therefore, the coils 74 and the wiring 77 can be connected to each other within the armature 72. This facilitates an insulation inspection at the time of manufacturing, and makes it possible to pull out the wiring 77 through, for example, the through-hole 78 of the rod 52. As a result, it is possible to hide the wiring 77 from the outside as much as possible to protect the entire wiring 77 from the outside, and prevent the wiring 77 from being unintentionally broken.

The fifth embodiment has been described based on an example in which the above-described features are applied to the electromagnetic suspension system 71 similar to the third embodiment. However, the features of the fifth embodiment can be applied to the electromagnetic suspension systems 21 and 61 according to the second and fourth embodiment.

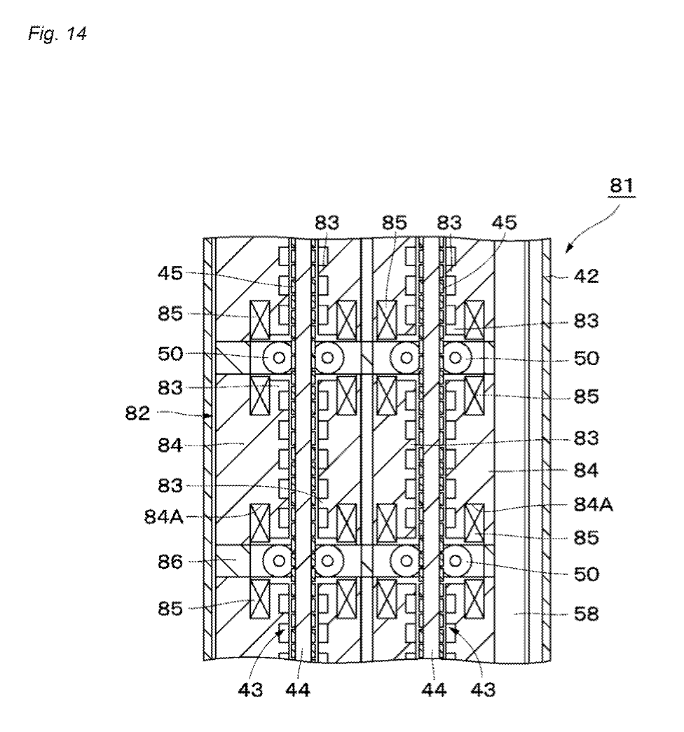

Next, FIG. 14 illustrates a sixth embodiment of the present invention. The sixth embodiment is characterized in that a magnetic pole is disposed between a coil and a movable element. In the following description, like components will be denoted by the same reference numerals as those in the above-described third embodiment, and the descriptions thereof will be omitted.

An electromagnetic suspension system 81 according to the sixth embodiment is configured in a substantially similar manner to the electromagnetic suspension system 41 according to the third embodiment of the present invention. Further, an armature 82 is configured in a substantially similar manner to the armature 46 according to the third embodiment, and includes magnetic poles 83, coils 85, and a core 86. Six magnetic poles 83 arranged side by side in the axial direction the connection portion 84 is sized so as to be shorter in the axial length than the six magnetic poles 83. Accordingly, a recess 84A is formed at each of the axial ends of the connection portion 84, and the coil 85 is disposed in the recess 84A. As a result, the magnetic poles 83 are positioned between the coil 85 and the movable element 43.

The number of the magnetic poles 83 around which the common coil 85 is wound may be any plural number of two or more, or may be only one. The number of the magnetic poles 83 may be arbitrarily set according to the design specification.

As configured in this way, the sixth embodiment can also provide substantially similar advantageous effects to those of the third embodiment. In the sixth embodiment, the magnetic poles 83 are positioned between the coil 85 and the movable element 43, and therefore, the permanent magnet 45, which faces the coil 85, can also contribute to generation of a thrust force. As a result, it is possible to reduce the electromagnetic suspension system 81 in size and weight, achieve thrust enhancement, and increase the damping coefficient.

Further, since the magnetic poles 83 are disposed between the coil 85 and the movable element 53, the coil 85 can be easily maintained in position, thereby reducing the possibility of a contact between the coil 85 and the movable element 43. As a result, even when the movable element 43 is deformed to contact the armature 82, the movable element 43 is prevented from contacting the coil 85, and prevent the coil 85 from being broken or shorting, thereby improving the reliability of the electromagnetic suspension system.

The sixth embodiment has been described based on an example in which this configuration is applied to the electromagnetic suspension system 81 similar to the third embodiment. However, the configuration according to the sixth embodiment can be also applied to the electromagnetic suspension systems, 1, 21, 61, and 71 according to the first, second, fourth, and fifth embodiment.

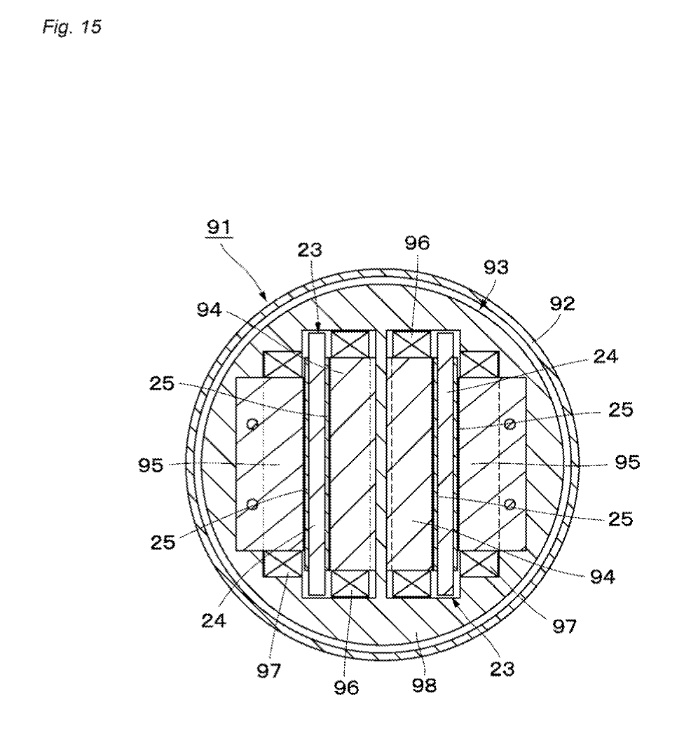

Next, FIG. 15 illustrates a seventh embodiment of the present invention. The seventh embodiment is characterized in that the outer profile of the electromagnetic suspension system is circular in cross section. In the following description, like components will be denoted by the same reference numerals as those in the above-described second embodiment, and the descriptions thereof will be omitted.

An electromagnetic suspension system 91 according to the seventh embodiment is configured in a substantially similar manner to the electromagnetic suspension 21 of the second embodiment. However, a casing 92 and an armature 93 are formed into a circular shape in cross section.

The armature 93 includes magnetic poles 94 and 95, coils 96 and 97, and a core 98. Diametrically-inner magnetic poles 94 are disposed at the diametrically inner side while being sandwiched by two movable elements 23. Diametrically-outer magnetic poles 95 are disposed at the diametrically outer side which corresponds to the outside of the two movable elements 23 in the thickness-direction. The magnetic poles 94 and 95 are connected to each other via the core 98. Diametrically-inner coils 96 are wound around the diametrically-inner magnetic poles 94, and diametrically-outer coils 97 are wound around the diametrically-outer magnetic poles 95.

Further, the Width dimension (the dimension in the vertical direction as viewed in the sheet of FIG. 15) of the diametrically-outer magnetic poles 95 is narrower than the width dimension of the diametrically-inner magnetic poles 94. Similarly, the width dimension of the diametrically-outer coils 97 is narrower than the width dimension of the diametrically-inner coils 96.

The height dimensions and the width dimensions of the diametrically-inner coils 96 and the diametrically-outer coils 97 may be arbitrarily set, and the diametrically-inner coils 96 and the diametrically-outer coils 97 may be configured so as to have the same number of windings but have different dimensions so that the magnetomotive force thereof match between the coils 96 and 97. Further, since the diametrically-inner coils 96 are in contact with the core 98 at a smaller area and therefore cannot release heat sufficiently compared to the diametrically-outer coils 97, the number of windings of diametrically-inner coils 96 may be reduced compared to the number of windings of the diametrically-outer coils 97. In this case, the number of windings subtracted from the diametrically-inner coils 96 may be added to the diametrically-outer coils 97.

As configured in this way, the seventh embodiment can also provide substantially similar advantageous effects to those of the second embodiment. Especially in the seventh embodiment, the outer profile of the electromagnetic suspension system 91 is circular in cross section, and this eliminates the necessity of consideration of the orientation of the electromagnetic suspension system 91 when the electromagnetic suspension system 91 is attached, thereby improving the attachment workability, compared to the electromagnetic suspension system quadrilateral in cross section. Further, this arrangement allows a coil spring to be attached at the outer circumference of the electromagnetic suspension system 91, thereby realizing an integration of the coil spring and the electromagnetic suspension system 91.

The seventh embodiment has been described based on an example in which this configuration is applied to the similar electromagnetic suspension system 91 to the second embodiment. However, the configuration according to the seventh embodiment can be applied to the electromagnetic suspension systems 1, 41, 61, 71, and 81 of the first, third to sixth embodiments.

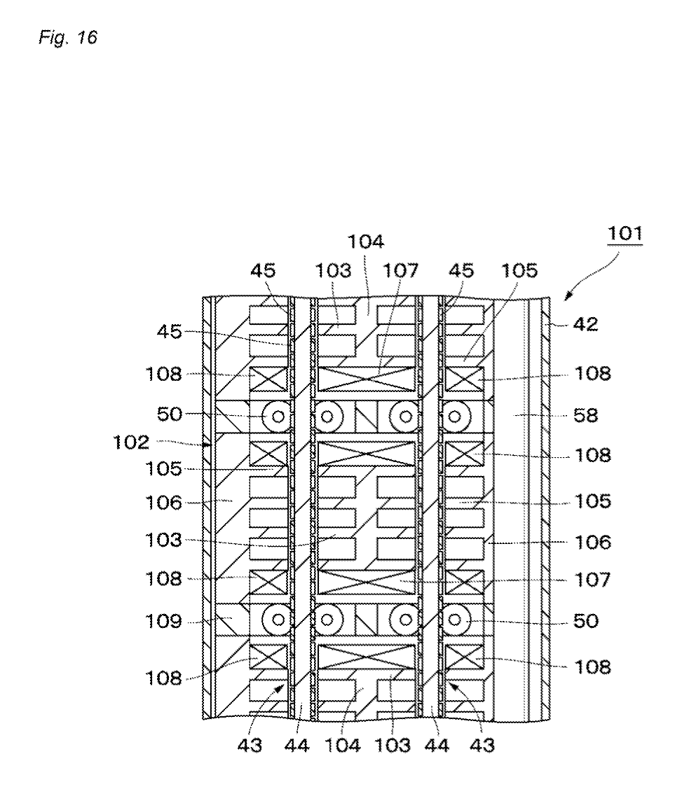

Next, FIG. 16 illustrates an eighth embodiment of the present invention. The eighth embodiment is characterized in that a common coil is wound around a plurality of magnetic poles sandwiched by two movable elements. In the following description, like components will be denoted by the same reference numerals as those in the above-described third embodiment, and the descriptions thereof will be omitted.

An electromagnetic suspension system 101 according to the eighth embodiment is configured in a substantially similar manner to the electromagnetic suspension system 41 according to the third embodiment.

An armature 102 includes magnetic poles 103 and 105, coils 107 and 108, and a core 109. Diametrically-inner magnetic poles 103 are disposed at the diametrically inner side while being sandwiched by the two movable elements 43. Further, the three magnetic poles 103 facing one of the movable elements 43, and the three magnetic poles 103 facing the other of the movable elements 43 are connected to each other via a connection portion 104. The coil 107 is wound around the connection portion 104.

Diametrically-outer magnetic poles 105 are disposed at the diametrically outer side which corresponds to the outer side in the thickness direction of the two movable elements 43. Further, the three magnetic poles 105 arranged side by side along the axial direction are connected to one another through a connection portion 106, and a common coil 108 is wound around the three magnetic poles 105 connected via the connection portion 106. The magnetic poles 103 and 105 are connected to each other via the core 109.

As configured in this way, the eighth embodiment can also provide substantially similar advantageous effects to those of the third embodiment. Especially in the eighth embodiment, the common coil 107 is wound around the magnetic poles 103 that are positioned in the middle (the second and third magnetic sets) of the four sets of magnetic poles 103 and 105 stacked in the thickness direction, and therefore the number of coils 107 can be reduced compared to an electromagnetic suspension system including a coil for each of the stacked four sets of magnetic poles. Therefore, although it tends to be difficult to release heat from the coil 107 at the middle in the stack, the configuration according to the present embodiment can reduce a heat generation amount of the coil 107. Further, if heat generation of the coil 107 at the middle in the stack may raise a problem, the number of windings of the coil 107 may be reduced to reduce the heat generation at the coil 107 to equalize the heat generation.

The first embodiment includes one movable element 3, but may include two or more movable elements. Further, the second to eighth embodiments include two movable elements 23, 43, and 62, but may be configured to include only one movable element or may include three or more movable elements.

In the respective above-described embodiments, the rotational mechanisms 16, 35, and 55 are contained in the casings 2, 22, 42, and 92. However, the present invention is not limited to this configuration, and may be configured in such a manner that the rotational mechanism is disposed, for example, at the distal end of the rod (protruding end), or that the rotational mechanism is provided between the cylindrical body of the casing and the attachment portion.

Further, in the respective above-described embodiments, the casings 2, 22, 42, and 92 are attached to the unsprung member, and the rods 13, 32, and 52 are attached to the sprung member. However, the present invention is not limited to this configuration, and may be configured in such a manner that the casing is attached to the sprung member and the rod is attached to the unsprung member.

According to the electromagnetic suspension systems in the above-described embodiments, the above-described configurations facilitate in employing the electromagnetic suspension system to the vehicle.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The entire disclosure of Japanese Patent Application No. 2011-041765 filed on Feb. 28, 2011 including specification, claims, drawings and summary is incorporated herein by reference in its entirety.

What is claimed is:

1. An electromagnetic suspension system comprising:
a casing attachable to a first attachment target member; and
at least one movable element and at least one armature, one of the movable element and the armature being fixedly disposed in the casing, the other of the movable element and the armature being movably disposed in the casing,
wherein the movable element includes a plurality of magnets disposed in a planar manner,
wherein the armature includes a plurality of magnetic poles disposed in a planar manner so that the movable element and the armature can have a relative movement therebetween,
wherein a rod extending in a direction of the relative movement is disposed at the other of the movable element and the armature movably disposed in the casing,
wherein the rod extends through a rod guide disposed at the casing to protrude to an outside of the casing, and is configured to be attachable to a second attachment target member, and
wherein the electromagnetic suspension system further comprises a rotational mechanism allowing a relative rotation between the first attachment target member and the second attachment target member.

2. The electromagnetic suspension system according to claim 1, wherein the rotational mechanism is disposed at a connection portion between the rod and the other of the movable element and the armature movably disposed in the casing.

3. The electromagnetic suspension system according to claim 1, wherein the movable element is fixedly disposed in the casing, and
wherein the rod is connected to the armature.

4. The electromagnetic suspension system according to claim 2, wherein the movable element is fixedly disposed in the casing, and
wherein the rod is connected to the armature.

5. The electromagnetic suspension system according to claim 1, wherein the at least one movable element includes two movable elements, and the two movable elements are fixed in the casing, and
wherein each of the movable elements has a plurality of magnets disposed on front and back surfaces thereof in a planar manner,
wherein the armature is movably disposed in the casing, and has a plurality of magnet poles respectively facing the front and hack surfaces of the two movable elements, and
wherein the rod is rotatably connected to a portion of the armature between the two movable elements.

6. The electromagnetic suspension system according to claim 5, wherein the rotational mechanism allowing a relative rotation between the first attachment target member and the second attachment target member is disposed at a connection portion between the rod and the armature.

7. The electromagnetic suspension system according to claim 1, wherein the rod guide functions as a lateral force support mechanism for supporting a lateral force in a direction perpendicular to a direction in which the rod extends.

8. The electromagnetic suspension system according to claim 1, wherein the casing is polygonal in cross section.

9. The electromagnetic suspension system according to claim 1, wherein a plurality of slide mechanisms is disposed between the movable element and the armature.

10. An electromagnetic suspension system comprising:
a casing attachable to a first attachment target member; and
at least one movable element and at least one armature, one of the movable element and the armature being fixedly disposed in the casing, and the other of the movable element and the armature being movably disposed in the casing,
wherein the movable element includes a plurality of magnets disposed in a planar manner,
wherein the armature includes a plurality of magnetic poles disposed in a planar manner so that the movable element and the armature can have a relative movement therebetween,
wherein a rod extending in a direction of the relative movement is disposed at the other of the movable element and the armature movably disposed in the casing,
wherein the rod extends through a rod guide disposed at the casing to protrude to an outside of the casing, and is configured to be attachable to a second attachment target member, and
wherein the electromagnetic suspension system further comprises a rotational mechanism allowing a relative rotation between the first attachment target member and the second attachment target member, the rotational mechanism being disposed at a connection portion between the rod and the other of the movable element and the armature movably disposed in the casing.

11. An electromagnetic suspension system comprising:
a casing attachable to a first attachment target member; and
at least one movable element and at least one armature, one of the movable element and the armature being fixedly disposed in the casing, the other of the movable element and the armature being movably disposed in the casing,
wherein the movable element includes a plurality of magnets disposed in a planar manner,
wherein the armature includes a plurality of magnetic poles disposed in a planar manner so that the movable element and the armature can have a relative movement therebetween,
wherein a rod extending in a direction of the relative movement is disposed at the other of the movable element and the armature movably disposed in the casing,
wherein the rod extends through a rod guide disposed at the casing to protrude to an outside of the casing, and is configured to be attachable to a second attachment target member,
wherein the electromagnetic suspension system further comprises a rotational mechanism allowing a relative rotation between the first attachment target member and the second attachment target member,
wherein the at least one movable element includes two movable elements, and the two movable elements are fixed in the casing, and
wherein each of the movable elements has a plurality of magnets disposed on front and back surfaces thereof in a planar manner,
wherein the armature is movably disposed in the casing, and has a plurality of magnet poles respectively facing the front and back surfaces of the two movable elements, and
wherein the rod is rotatably connected to a portion of the armature between the two movable elements.
